(19) United States
(12) Patent Application Publication
(10) Pub. No.: US 2010/0004007 A1
(43) Pub. Date: Jan. 7, 2010

(54) AUTOMATED INTERACTIVE SMS SERVICE SYSTEM

(76) Inventors: John Vogel, Mercer Island, WA (US); Mike Martinez, Issaquah, WA (US); Druce MacFarlane, Edmonds, WA (US)

Correspondence Address: Vierra Magen Marcus & DeNiro LLP, 575 Market Street, Suite 2500, San Francisco, CA, 94105, US

(21) Appl. No.: 12/166,655

(22) Filed: Jul. 2, 2008

(51) Int. Cl. H04Q 7/20

(52) U.S. Cl. 455/466

(57) ABSTRACT

A method and system are disclosed for providing bidirectional communication between the system and a client device using standard text messaging technologies, such as SMS. Communication may be originated from the client device or from the system. Users may request specific information from the system using SMS that is delivered to the user through either SMS, multimedia messaging service or email technologies. In other circumstances, the system may request feedback from the user. Such circumstances may include appointment confirmation, customer satisfaction surveys, or other system confirmation messages.

### BACKGROUND

1. Field of the Invention

Embodiments of the present invention relate to an automated interactive system providing bidirectional communication between the system and a client device using standard text messaging technologies such as a short message service.

2. Description of the Art

Short message service (SMS) has become a popular text-based protocol for exchanging short text messages between cellular networks and wireless devices such as cellular phones. Different SMS implementations have been defined for different mobile networking protocols. For example, the SMS implementation for a Global System for Mobility (GSM) network is described in a document entitled “Teleservices Supported by a GSM Public Land Mobile Network (PLMN).” The SMS implementation for an ANSI-41 network is described in document TIA/EIA-637-B, entitled “Short Message Service for Wideband Spread Spectrum Systems.” Both of these documents are publicly available and are incorporated herein by reference.

While SMS text messages are typically manually generated by a cellular phone user and sent to one or more recipient cellular phone users, it is also known to generate and send automated SMS text messages. For example, businesses are beginning to employ automated SMS text messaging as part of their customer service program. In such an implementation, an application server within a business generates a message according to the predefined criteria created by the business. For example, a business may wish to remind a customer of an upcoming appointment, or thank a customer for recent patronage. The messages are sent from the application server to a customer's device via an SMS gateway. An SMS gateway is a software interface allowing SMS messages to be transferred between mobile networking protocols and other protocols, such as TCP/IP used by the World Wide Web.

Existing automated SMS text messaging systems are useful in providing one-way alerts, but do not currently allow users to interact with the system sending the one-way message.

### SUMMARY

Embodiments of the present system, roughly described, relate to a system providing bidirectional communication between the system and a client device using standard text messaging technologies such as SMS. In different embodiments, communication may be originated from the client device or from the system. For example, in a first embodiment, the system may be used for automated and interactive confirmation of an appointment or other event and, if desired, rescheduling of the event. If the customer wishes to reschedule an event, the system provides the customer with the option to establish a live telephone call with a service representative. If the customer selects this option, the system bridges the call between the customer and service representative. In this way, the present system provides automated interactive assistance to the customer and also allows the customer to speak in person with a service representative when desired.

Instead of confirming a future event, the system may also be used to receive feedback on an event that has already occurred, such as for example customer satisfaction surveys. In such an embodiment, the system would contact a customer after an event, and conduct automated and interactive communications with the customer to receive feedback. Again, if the customer wishes, a live telephone call may be bridged by the system between the customer and a service representative to discuss the customer's experience.

In further embodiments, the customer may initiate contact with the interactive system for the purpose of obtaining information on an item of interest to the customer. The customer may request specific information from the system using SMS and the system may respond with the information via SMS, multimedia messaging service and/or email technologies.

### BRIEF DESCRIPTION OF THE DRAWINGS

FIG. 1 is a block diagram of a system for bidirectional communication between the system and a client device.

FIGS. 2A and 2B are a flowchart of a first embodiment using the system of FIG. 1 to confirm and possibly reschedule an event.

FIGS. 3A and 3B are a flowchart of a second embodiment using the system of FIG. 1 to receive feedback on a past event.

FIG. 4 is a flowchart of a third embodiment for a customer to receive information on an item of interest.

### DETAILED DESCRIPTION

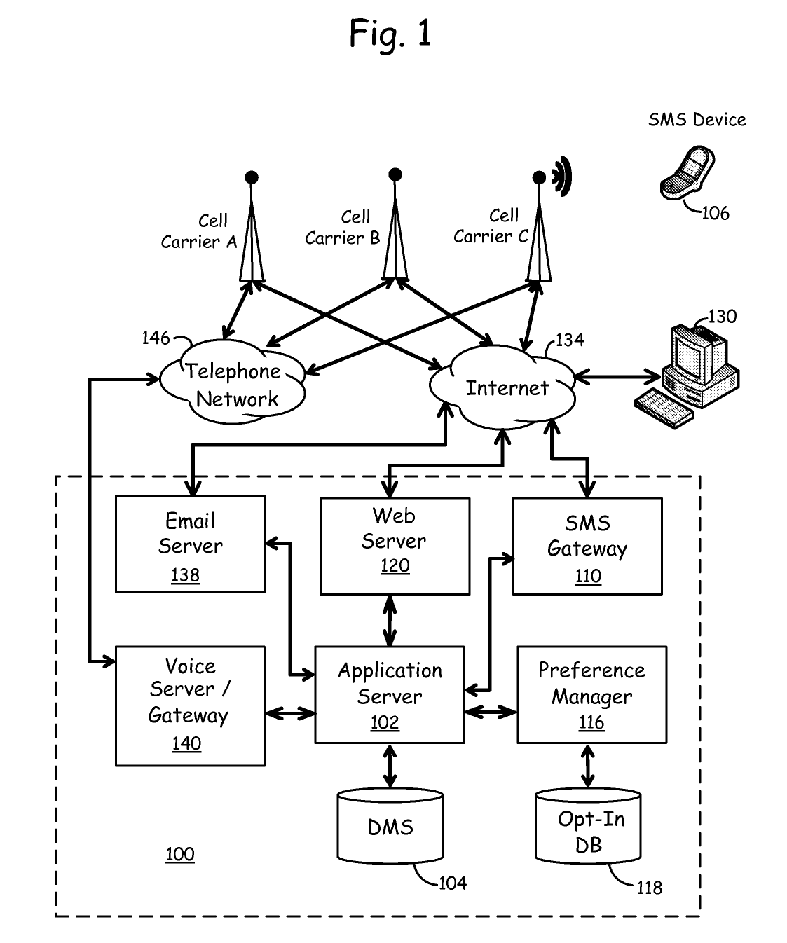

The present invention will now be described with reference to FIGS. 1 through 4, which in general relate to a system providing bidirectional communication between the system and a client device using standard text messaging technologies. While the following description uses SMS as the text based technology, it is understood that the present invention may be carried out by other text-based technologies in alternative embodiments. It is further understood that the present invention may be embodied in many different forms and should not be construed as being limited to the embodiments set forth herein. Rather, these embodiments are provided so that this disclosure will be thorough and complete and will fully convey the invention to those skilled in the art. Indeed, the invention is intended to cover alternatives, modifications and equivalents of these embodiments, which are included within the scope and spirit of the invention as defined by the appended claims. Furthermore, in the following detailed description of the present invention, numerous specific details are set forth in order to provide a thorough understanding of the present invention. However, it will be clear to those of ordinary skill in the art that the present invention may be practiced without such specific details.

FIG. 1 shows a block diagram of a system 100 for carrying out embodiments of the present invention. The system 100 includes an application server 102 executing an application program for generating messages and responding to messages as explained hereinafter. In one embodiment, the system 100 may be used as an automated and interactive customer service tool for a business such as an automobile dealership or other dealership. Automobile dealerships may employ a dealership management system (DMS) 104 which, as is known in the art, may be a database used by a dealership to track a wide variety of information relating to its business, including for example vehicle inventory, sales, financing, automobile service records, customers, customer transactions and appointment scheduling. DMS 104 may store data relating to additional dealership functions.

As described in greater detail below, in embodiments, the application server sends SMS-conforming text messages to, and receives SMS-conforming text messages from, end-user cellular telephones 106 (one example of which is shown in FIG. 1) through an SMS gateway 110. It is understood that other SMS-capable devices may be used in the place of or in addition to cellular telephone 106, and, as indicated above, text messages may be exchanged by protocols other than SMS. In embodiments, text messages are transferred to and from system 100 via SMS gateway 110 by short message peer-to-peer protocol (SMPP), but messages may be transferred by other technologies in further embodiments. SMS messages may be sent to GSM-capable cellular telephones, but SMS messages may be sent to phones operating by other standards in alternative embodiments.

System 100 additionally includes a preference manager 116 and an opt-in database 118. As explained hereinafter, before the system 100 interacts with an end user in certain embodiments, the end user must subscribe, or opt into, the services provided by the system 100. Accordingly, preference manager 116 is provided to manage the opt-in process and opt-in database 118 is provided to store the identity of all end users who have opted into the services of system 100.

System 100 further includes a web server 120 for allowing an entity 130 such as an automobile or other dealership to access the system 100 via a network 134, which may for example be the Internet. As explained below, an entity 130 may upload information to the DMS 104 via the web server 120. An email server 138 is further provided within system 100 for sending emails to entity 130 and end users as explained hereinafter. System 100 may additionally include a voice server/gateway 140 for bridging telephone calls between entity 130 and an end user cellular phone 144 via a telephone network 146. It is understood that system 100 may include additional components and/or that one or more of the above-described components may be omitted in certain embodiments.

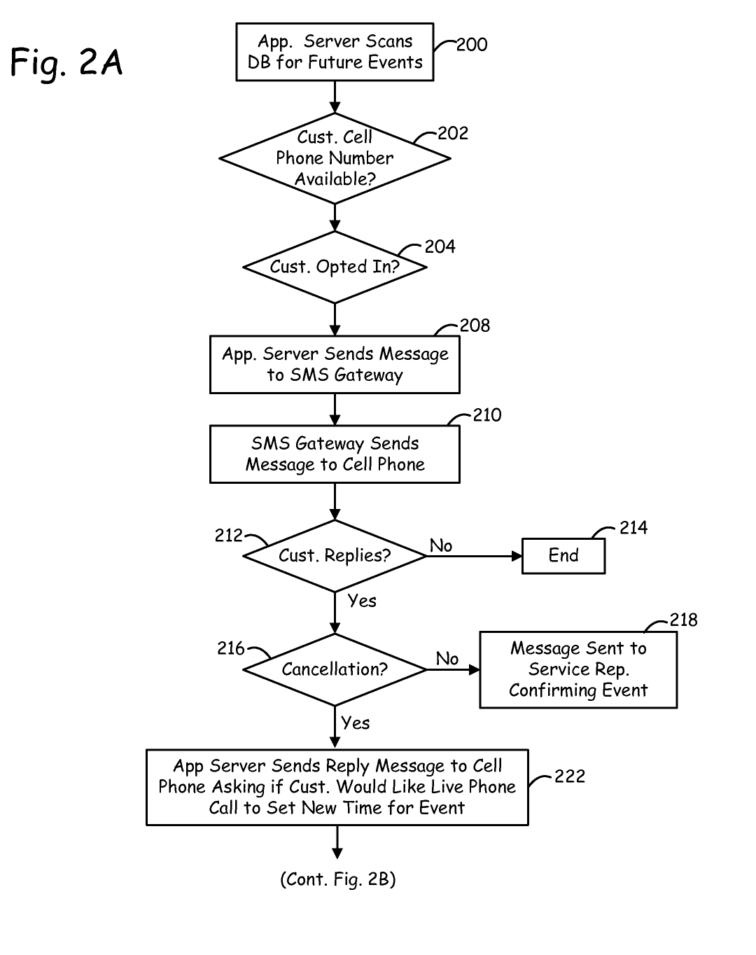

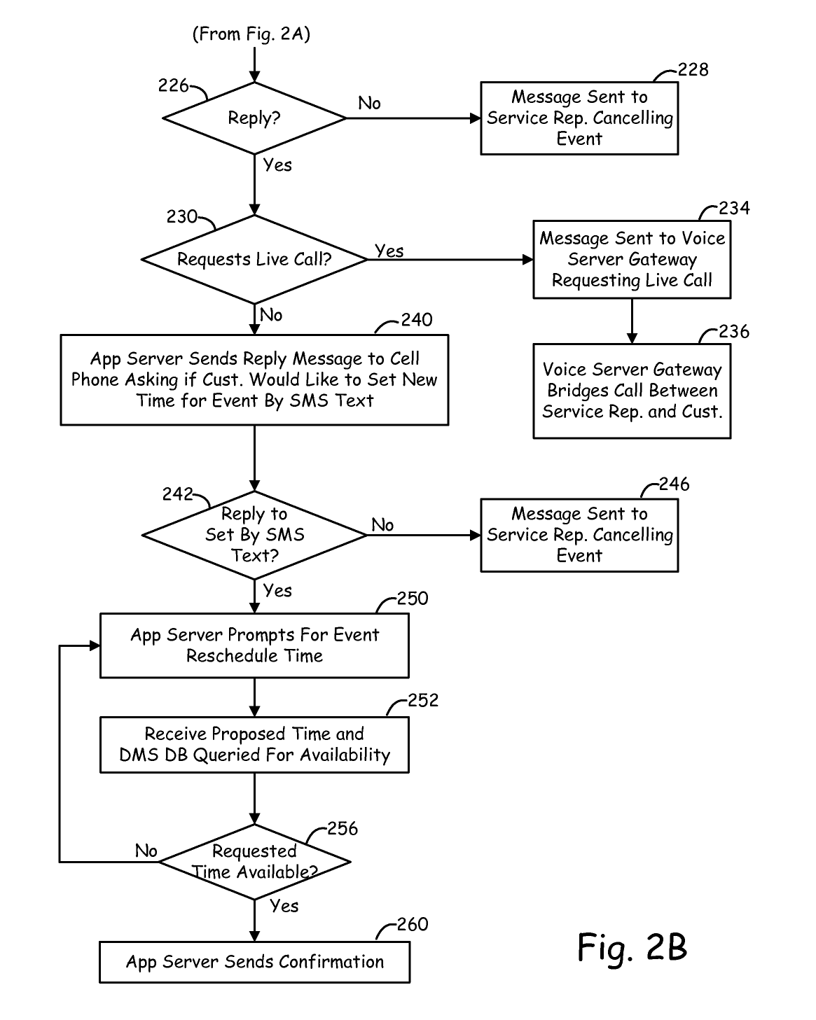

The operation of system 100 will now be described with respect to three operational embodiments of system 100. It is understood that system 100 may be used for operations beyond the three embodiments described below. The flowchart of FIGS. 2A and 2B relates to an embodiment where system 100 is used to confirm and event and, if desired, reschedule the event. In one example, entity 130 may be an automobile dealership having scheduled appointments for customers to bring their cars in for service. However, the system 100 may be used in any circumstance where an entity wishes to use text messaging systems to confirm information. This may include, but is not limited to, an entity that requests permission to disclose personal information, confirm changes to account information, confirm opt-in status for other systems, and confirm purchases using a financial system or a loyalty point system.

In an example relating to an automobile dealership, prior to a customer interacting with the system 100, all scheduled appointments would be stored within DMS 104. In particular, an administrator or another within entity 130 can store information on DMS 104 via web server 120, including for example customer contact name, number, address, appointment date and time, service representative and service requested. Other and/or additional information may also be uploaded to DMS 104 via the web server 120. In embodiments not relating to an automobile dealership, DMS 104 would be replaced by some other database including information relating to scheduled events.

In step 200, the application server 102 may periodically scan DMS 104 to obtain a list of all events occurring within a given future time window. For example, the application server may look for all events scheduled to occur within the next 24 hours. For a given scan, this may return no events, one event or more than one event. In step 202, the application server 102 determines whether DMS 104 has a customer cell phone number associated with a customer having an event within the scheduling window. If not, system 100 goes no further, and the event remains scheduled as planned. If there is an associated cellular phone number, the application server 102 next queries preference manager 116 in step 204 to determine whether the customer(s) having scheduled events within the scanned period have opted into the service provided by system 100. If not, the process ends, and the event remains scheduled as planned.

If on the other hand, application server 102 has determined that a customer has opted in, the application server generates and sends a message to SMS gateway 110 in step 208. The generated message is sent to each customer identified in steps 200-204. While this may result in several messages and interactions, the following describes a single such interaction. It is understood that the following interaction may occur for each customer identified after steps 200-204.

The message sent to the SMS gateway 110 will include a user's cellular telephone number, a message reminding the user of an upcoming event, and a request for the user to confirm the event. For example, the generated message may be as follows: “Hello, this is just to remind you that you have a service appointment with ABC tomorrow at X:YY. If you cannot make this appointment, please reply to this message with a ‘NO.’ If for any reason you cannot make this time, reply with the word ‘NO’.”

This message is then sent in step 210 from SMS gateway 110 over network 134 to the recipient cellular phone 104 via one of the cell carriers A, B, C (there may be more or less than three cell carriers in further embodiments). In step 212, SMS gateway 110 looks for a reply from cellular phone 104. If the system does not receive a reply from cellular phone 104 (for example within a present time period), the process ends, and the event remains scheduled as planned. If, on the other hand, SMS gateway 110 receives a reply, SMS gateway 110 forwards the reply to application server 102.

In step 216, application server 102 determines whether the reply is a cancellation. As is known, application server may recognize a variety of responses as indicating a desire to cancel an appointment. If the reply is not a cancellation, the application server 102 causes a message to be sent to a service representative within the entity 130 in step 218 confirming the scheduled time for the event. This message may be sent to the service representative's email account through email server 138, and/or this message may be sent as an SMS text message to the service representative's cellular phone via SMS gateway 110.

If, on the other hand, a user cancels the event in step 216, application server 102 generates a message in step 222 asking the customer if they would like to engage in a live phone conversation to set up a new scheduled time for the event. The message may for example be: “If you would like us to call you back immediately to schedule an appointment, reply with ‘call’.” This message is sent to cellular phone 104 by SMS gateway 110. In step 226 (FIG. 2B), the system 100 looks for a reply. If no reply is received (for example within a preset period of time), the application server 102 will send a message to email server 138, which in turn sends an email to the entity 130 to cancel the event. The email may additionally prompt a service representative at entity 130 to schedule a time to call the customer to attempt to reschedule the event.

If, on the other hand, the customer replies in step 226, the reply is forwarded to the application server 102. The application server 102 determines in step 230 whether the customer has requested a live call. If so, the application server causes a telephone call to be bridged between the customer and a service representative at the entity 130. In particular, in step 234, the application server 102 sends a message to voice server/gateway 140 to establish a call between the customer and service representative at the entity 130, and in step 236, the voice server/gateway establishes this call. The voice server/gateway first contacts the service representative, then the customer and bridges the call between the two. In this way, the present system provides automated interactive assistance to the customer and also allows the customer to speak in person with a service representative when desired. In alternative embodiments, a customer may reply to an SMS text message received from system 100 at any stage of the process with a request to bridge a live telephone call. In this embodiment, a live telephone call will be established upon receiving such a request.

If it is determined in step 230 that a live call is not requested, the application server 102 may send a reply through SMS gateway 110 in step 240 asking if the customer would like to set up a new event time by SMS text. In step 242, if no reply is received (for example within a preset time period), the application server causes an email to be sent in step 246 to the service representative at entity 130 to cancel the event. The email may also prompt the service representative to call the customer to reschedule the event. Step 246 may alternatively be sent as SMS text through SMS gateway 110.

If a reply is received in step 242 to reschedule by SMS text, the application server 102 responds via SMS gateway 110 in step 250 with a request for a proposed rescheduled time. Upon receipt of a proposed time, the DMS database is queried to confirm whether that time is available in step 252. If it is determined in step 256 that the proposed time is available, the application server 102 sends a confirmation of the rescheduled event time via the SMS gateway 110 in step 260. If, on the other hand, it is determined in step 256 that the proposed time is not available, the application server again performs step 250 of sending a request to the customer for a proposed reschedule time.

The steps 240 through 260 of allowing a customer to reschedule by text messaging may be omitted in alternative embodiments of the present system. The customer is given the option to bridge a live telephone call to reschedule and, if the customer declines, the event is cancelled. In any of the above-described embodiments, in the event of a canceled event that is not rescheduled, the service representative may receive periodic messages (via email and/or text) prompting the service representative to contact the customer to reschedule.

The above description relates to contacting customers to remind them of scheduled events. In a further embodiment, the system 100 may also operate in a similar manner to remind users to make scheduled service appointments after a defined period of time following their last service appointment. The entity 130 may configure the period of time since last service as the trigger for such notifications.

In the embodiments described above and hereinafter, all SMS communications may be conducted using the security measures dictated by the cellular carriers. In embodiments, an additional encryption layer may be added to ensure that information sent via SMS or email relating to the customer and/or products is communicated securely.

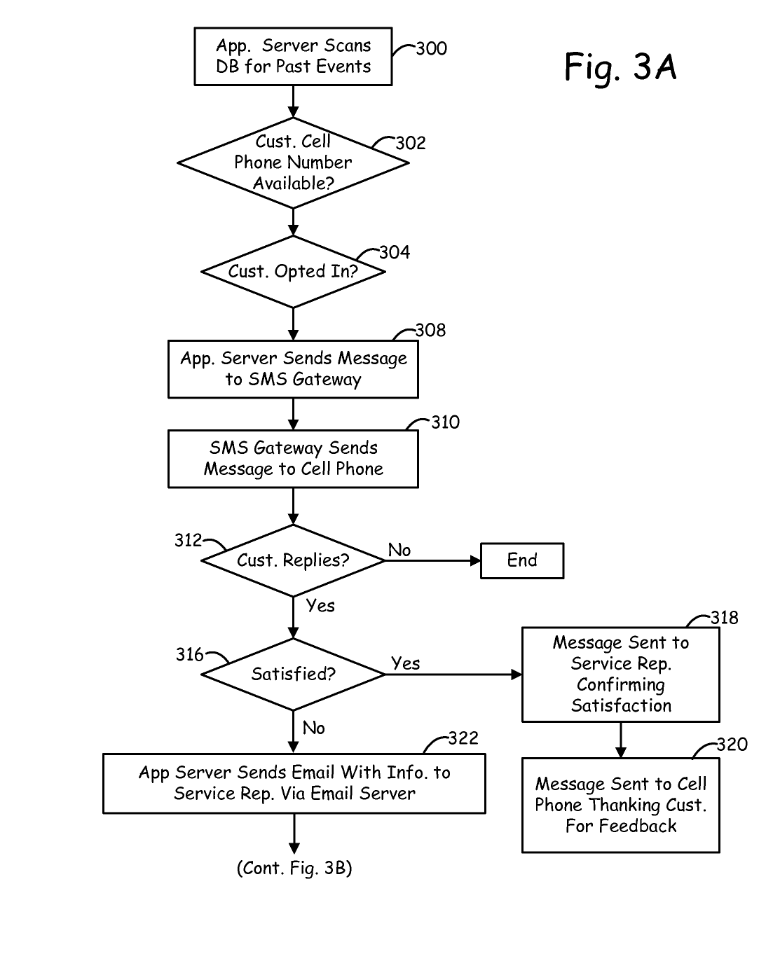

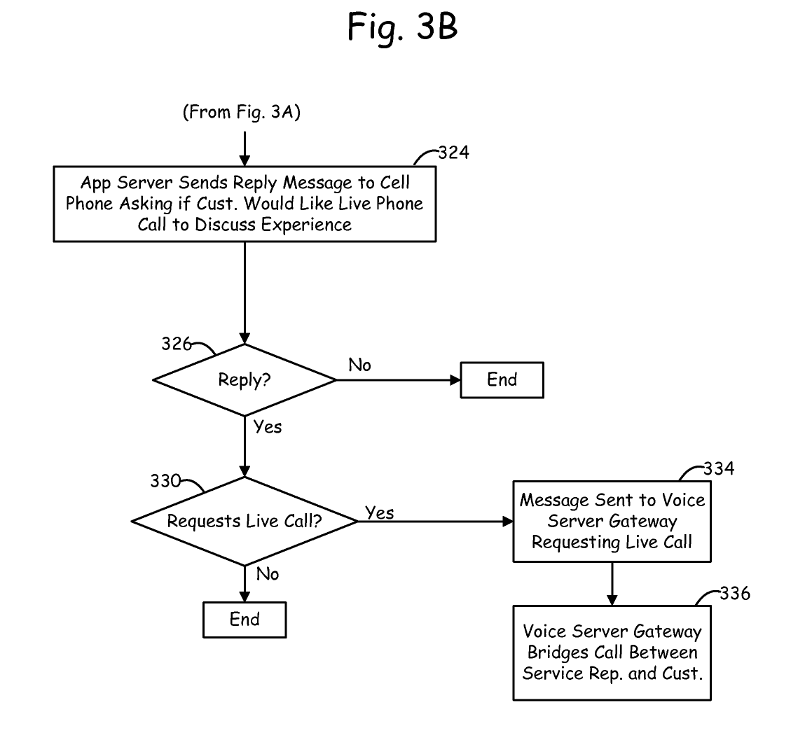

FIGS. 2A and 2B illustrate a process for confirming a future event. FIGS. 3A and 3B illustrate a process using system 100 for interacting with a customer regarding a past event. A common example may be contacting a customer to receive customer feedback on a recent event, such as a service appointment. In step 300, the application server 102 may periodically scan DMS 104 to obtain a list of all events which occurred within a preset window of time in the past. For example, the application server may look for all events which occurred in the last 24 hours. For a given scan, this may return zero, one or more events. In step 302, the application server 102 confirms there is a cellular phone number for the customer, and in step 304, the application server confirms that the customer has opted into the service provided by system 100. If either of steps 302 or 304 is not confirmed, the process ends and no message is sent to the customer.

If on the other hand, application server 102 determines that a customer has a listed cellular number and has opted in, the application server generates and sends a message to SMS gateway 110 in step 308. The generated message is sent to each customer identified in steps 300-304. The following describes a single such interaction. It is understood that the following interaction may occur for each customer identified after steps 300-304.

The message sent to the SMS gateway 110 will include a user's cellular telephone number, and a message requesting information, such as feedback, on a past event. For example, the generated message may be: “Hello from xyz. We wanted to know if you have been completely satisfied with your experience here at xyz? Respond back with YES or NO.” While a yes or no answer is advantageously simple, and customer may additionally or alternatively be prompted to rate their experience on a numeric scale.

This message is then sent in step 310 from SMS gateway 110 over network 134 to the recipient cellular phone 104 via one of the cell carriers. In step 312, SMS gateway 110 looks for a reply from cellular phone 104. If SMS gateway 110 does not receive a reply from cellular phone 104, the process ends. If, on the other hand, SMS gateway 110 receives a reply, SMS gateway 110 forwards the reply to application server 102.

In embodiments seeking customer feedback, in step 316, application server 102 determines whether the reply indicates satisfaction or dissatisfaction with the recent event. As is known, application server may recognize a variety of responses as indicating such satisfaction or dissatisfaction. If the reply indicates satisfaction, the application server 102 causes a message to be sent to a service representative within the entity 130 in step 318 indicating such satisfaction. This message may be sent to the service representative's email account through email server 138, or this message may be sent as an SMS text message to the service representative's cellular phone via SMS gateway 110. The application server 102 may then send a thank you message via the SMS gateway in step 320, such as for example: “Thank you for participating in our customer feedback system. If you need anything, please call us at xxx-xxx-xxxx.”

If, on the other hand, a customer indicates dissatisfaction in step 316, application server 102 causes the email server 138 to send an email in step 322 to the service representative at entity 130 indicating the customer's dissatisfaction. The application server also obtains available information relating to the event from DMS 104 and includes that information in the email. The application server 102 further causes a message to be sent via the SMS gateway 110 in step 324 (FIG. 3B) asking the customer if they would like to engage in a live phone conversation to discuss the event. The message may for example be: “I am sorry you had a bad experience. Our manager will be contacting you shortly to see how we can rectify this situation. If you would like that call now, reply with the word CALL.”

In step 326, SMS gateway 110 looks for a reply. If no reply is received, the process ends. If, on the other hand, the customer replies in step 326, the reply is forwarded to the application server 102. The application server 102 determines in step 330 whether the customer has requested a live call. If not, the process ends. If so, the application server 102 causes a telephone call to be bridged between the customer and a service representative at the entity 130 in steps 334 and 336 (similar to steps 234 and 236 described above with respect to FIG. 2B).

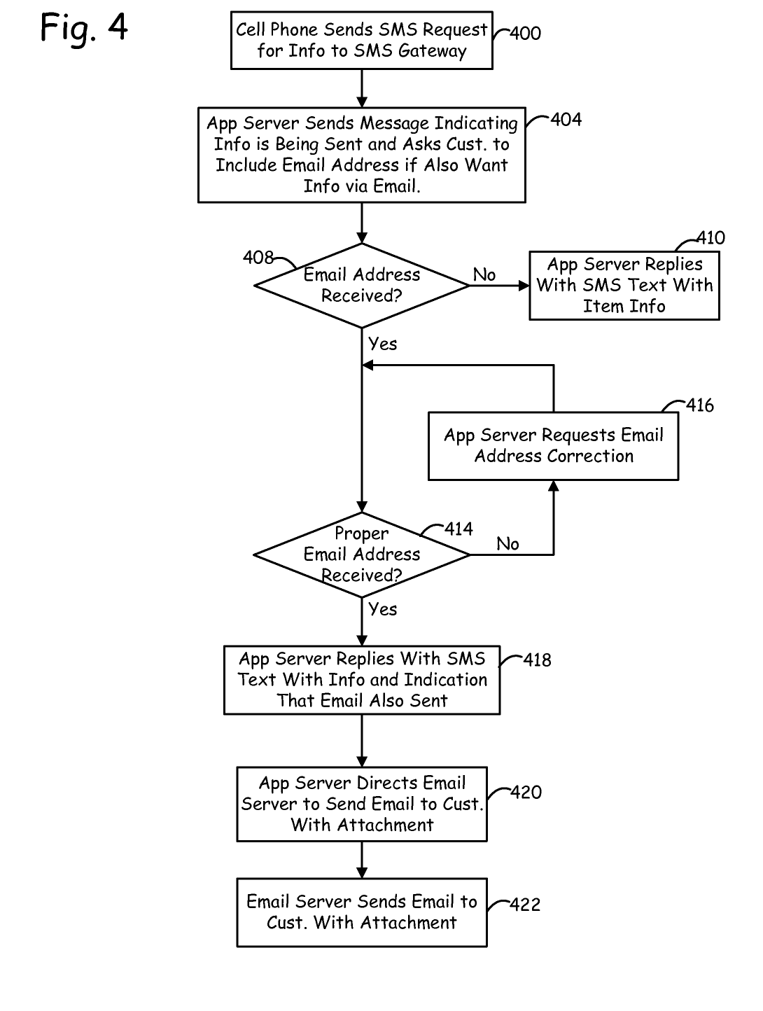

In the examples described above, contact is initiated by the system 100. Further embodiments may operate upon the customer initiating contact. One such example is described with regard to FIG. 4. In the process of FIG. 4, a customer may wish to receive information regarding an entity's products or services via system 100. For example, a customer may wish additional information relating to an automobile or other item that the customer has seen in an advertisement. Alternatively, the customer may be at a dealership and wants more information about an automobile without having to speak to a sales representative.

In this example, at some point prior to a customer contacting an entity requesting information regarding an item, the information relating to the item may be uploaded to the DMS by an administrator or another at entity 130 via web server 120. The information may be uploaded in a variety of formats and/or in multiple formats. For example, if there is only alphanumeric information relating to the item, the information can be stored in DMS 104 in a format suitable for inclusion in an SMS message. However, an entity 130 may also want to include pictures of an item. If so, the uploaded information may include graphics such as a jpeg, gif, etc. for inclusion in a multimedia messaging service (MMS) message to be sent to customers. In addition to one of the above formats, an entity may also choose to upload high resolution graphics and more detailed information relating to an item, which information is intended to be sent to customers in an email. These cases are discussed in greater detail below. In embodiments, an administrator within entity 130 may upload a graphic file, which is automatically formatted by the application server 102 as a low resolution image for the MMS message, as well as a high resolution image for the email.

When the customer sees the item, or an advertisement for the item, the item/advertisement may include a tag with a statement such as: “For More information Text ‘Get 123xxxxxxx’ to yyy-yyy-yyyy.” The “123” portion of the SMS text may uniquely identify a particular service provider, such as for example a particular auto dealer in the current example. The “xxxxxxx” portion of the SMS text may uniquely identify a stock number of the particular item of interest, such as for example the specific automobile of interest to the customer. Such a text may be received by the SMS gateway 110 in step 400. The system 100 may alternatively receive SMS text information in addition to that described above, or the system may only receive portions of the SMS text information described above. For example, if the customer omits either the service provider number or stock number, the SMS gateway 110 may prompt the customer to enter this information.

In step 404, the application server 102 sends a message via SMS gateway 110 to the customer indicating that the requested information is being sent and asking whether the customer would also like the information sent to an email account. If so, the customer is asked to respond with an email. If it is determined in step 408 that the customer has not requested an email, the requested information is obtained from the DMS 104 and forwarded to the customer in step 410 in SMS, MMS or other format.

On the other hand, if a user responds with an email in step 408, the application server 102 checks whether the email is valid in step 414. If not, the customer is sent a message in step 416 requesting that the email be resent. If the email is valid, the application server obtains the requested information from the DMS 104 and the information is sent to the customer in an SMS or MMS message via the SMS gateway in step 418. The customer is also sent an indication that an email has been sent to the specified email account. In step 420, the application server obtains the email attachment version of the requested information from DMS 104, and in step 422, the email server 138 forwards the email to the customer email account.

The foregoing detailed description of the inventive system has been presented for purposes of illustration and description. It is not intended to be exhaustive or to limit the inventive system to the precise form disclosed. Many modifications and variations are possible in light of the above teaching. The described embodiments were chosen in order to best explain the principles of the inventive system and its practical application to thereby enable others skilled in the art to best utilize the inventive system in various embodiments and with various modifications as are suited to the particular use contemplated. It is intended that the scope of the inventive system be defined by the claims appended hereto.

We claim:

1. A method of automated interaction between a system and a user of a SMS-capable device, comprising the steps of:
(a) sending an SMS text message from the system to the SMS-capable device, the SMS text message including a request for a response; and
(b) performing one or more actions of a plurality of different actions based on whether a response is received by the system in reply to the request for a response in said step (a), and based on what the response is if a response is received by the system.

2. A method as recited in claim 1, wherein the request for a response in said step (a) comprises the step of requesting a user of the SMS-capable device to confirm a future event.

3. A method as recited in claim 2, wherein said step (b) of performing one or more actions comprises the step of sending a notice of cancellation of the event where the response indicates the user wishes to cancel the event.

4. A method as recited in claim 3, wherein said step of sending a notice of cancellation of the event comprises the step of sending an email to a service representative associated with the event that the event is canceled.

5. A method as recited in claim 3, further comprising the step of sending a second SMS text from the system upon the system receiving an indication the user wishes to cancel the event, the second SMS text message including a request for the user to reschedule the event.

6. A method as recited in claim 2, wherein the request to confirm a future event comprises the step of requesting the user to confirm a future automobile service appointment.

7. A method as recited in claim 1, wherein the request for a response in said step (a) comprises the step of requesting a user of the SMS-capable device to comment on a past event.

8. A method as recited in claim 7, wherein said step (b) of performing one or more actions comprises the step of sending a notice to a service representative associated with the event for the service representative to follow up with the user when the comment on the past event is a negative comment.

9. A method as recited in claim 7, wherein the step of requesting a user of the SMS-capable device to comment on a past event comprises the step of requesting the user of the SMS-capable device to provide performance feedback on a past automobile service appointment.

10. A method of automated interaction between a system and a user of a text-capable device, comprising the steps of:
(a) sending text message from the system to the text-capable device, the text message including a request for a response;
(b) receiving a response to the request from the text-capable device in the system; and
(c) sending a second text message from the system to the text-capable device in reply to the response received in said step (b), the second text message offering to bridge a live telephone call between the user of the text-capable device and a service representative associated with the event.

11. A method as recited in claim 10, further comprising the step (d) of bridging the live telephone call in the event a response is received from the text-capable device indicating a desire to have the live telephone call.

12. A method as recited in claim 11, wherein the request for a response in said step (a) comprises the step of requesting a user of the text-capable device to confirm a future appointment.

13. A method as recited in claim 12, wherein said step (b) comprises the step of receiving an indication the user wishes to cancel the scheduled appointment.

14. A method as recited in claim 11, wherein the request for a response in said step (a) comprises the step of requesting a user of the text-capable device to comment on a past event.

15. A method as recited in claim 14, wherein the step of requesting a user of the text-capable device to comment on a past event comprises the step of requesting the user of the text-capable device to provide performance feedback on a past automobile service appointment.

16. A method as recited in claim 11, wherein said step (a) of sending a text message comprises the step of sending a text message via SMS protocols.

17. A method of automated interaction between a system and a user of a text-capable device, comprising the steps of:
(a) sending a first text message from the system to the text-capable device, the text message including a request for the user to confirm an upcoming appointment;
(b) sending a message to a service representative associated with the appointment confirming the appointment in the event the user responds with a text message confirming the appointment; and
(c) sending a second SMS text message from the system to the SMS-capable device in the event the user responds with an SMS text message canceling the appointment, the second SMS text message offering to perform at least one of the steps of: (i) bridging a live telephone call between the user of the SMS-capable device and a service representative associated with the event; and (ii) setting a new date and time for the appointment via a further exchange of SMS text messages.

18. A method as recited in claim 17, wherein said step (b) of sending a message to the service representative associated with the appointment comprises the step of sending an email confirmation to the service representative.

19. A method as recited in claim 17, wherein said step (b) of sending a message to the service representative associated with the appointment comprises the step of sending a text confirmation to the service representative.

20. A method as recited in claim 17, wherein the request to confirm an upcoming appointment in said step (a) comprises the step of requesting the user to confirm an upcoming automobile service appointment.

21. A method of automated interaction between a system and a user of a text-capable device, comprising the steps of:
(a) sending a first text message from the system to the text-capable device, the text message including a request for the user to provide feedback on a past appointment;
(b) sending a message to a service representative associated with the appointment including information relating to the user, the past appointment and the feedback from the user received in response to the request of said step (a); and
(c) sending a second text message from the system to the text-capable device in the event the user responds with a text message with a negative feedback, the second text message offering to bridge a live telephone call between the user of the text-capable device and a service representative associated with the event.

22. A method as recited in claim 21, wherein said step (b) of sending a message to the service representative associated with the appointment comprises the step of sending an email message to the service representative.

23. A method as recited in claim 21, wherein said step (b) of sending a message to the service representative associated with the appointment comprises the step of sending a text message to the service representative.

24. A method as recited in claim 21, wherein the request to confirm an upcoming appointment in said step (a) comprises the step of requesting the user to provide feedback relating to a past automobile service appointment.

25. A method of automated interaction between a system and a user of a text-capable device, comprising the steps of:
(a) receiving a text message from the text-capable device within the system, the text message including a request for information relating to an item;
(b) sending a text message from the system to the text-capable device offering to forward information relating to the item according to at least one of a text protocol and an email protocol; and
(c) forwarding the information relating to the item according to at least one of the text protocol and email protocol based on a response to the offer sent in said step (b).

26. A method as recited in claim 25, further comprising the steps of requesting and receiving an email address via SMS text for the user before the system forwards the information relating to the item according to an email protocol.

27. A method as recited in claim 25, further comprising the step of uploading the information relating to the item to a database associated with the system prior to said step (a).

28. A method as recited in claim 27, wherein said step of uploading the information relating to the item comprises the step of uploading alphanumeric text for forwarding as an SMS text message.

29. A method as recited in claim 27, wherein said step of uploading the information relating to the item comprises the step of uploading alphanumeric text and at least one graphics file for forwarding as an MMS message.

30. A method as recited in claim 27, wherein said step of uploading the information relating to the item further comprises the step of uploading alphanumeric text and at least one graphics file for forwarding as part of an email.
